(19) United States
(12) Patent Application Publication
(10) Pub. No.: US 2017/0057854 A1
(43) Pub. Date: Mar. 2, 2017

(54) Ion Exchange Regeneration Process Utilizing Membrane Distillation

(71) Applicant: PEPSICO, INC., Purchase, NY (US)

(72) Inventors: Jim Tsungyeh Yu, Hawthorne, NY (US); Eric Jon Willman, Hawthorne, NY (US); Arun Sathyagal, Hawthorne, NY (US)

(21) Appl. No.: 14/841,980

(22) Filed: Sep. 1, 2015

(51) Int. Cl. C02F 9/00; B01D 15/36; B01D 61/14; B01D 61/36; B01D 15/20; B01D 61/58

(52) U.S. Cl. CPC C02F 9/00; B01D 15/203; B01D 61/58; B01D 61/145; B01D 61/364; B01D 15/362; C02F 2001/425

(57) ABSTRACT

Method for treating effluent waste from a cation-exchange column regeneration cycle, including backwashing the column; regenerating the column using rinse water and a regenerant brine having a temperature warmer than room temperature, thereby forming a waste effluent containing divalent cations; precipitating the divalent cations in a precipitation reactor at a temperature warmer than room temperature; filtering the precipitation effluent; optionally, adjusting the filtered precipitation effluent pH; concentrating the filtered precipitation effluent via membrane-based water recovery, thereby forming separated concentrated salt and pure rinse water; and recirculating the separated concentrated salt and pure rinse water back to the column for a subsequent regeneration cycle. Also, a system including an exhausted cation-exchange column; a chemical precipitation reactor; a filtration unit; an optional pH adjustment unit; and a membrane-based water recovery unit, wherein the system is a closed-loop through which salt and rinse water having a temperature warmer than room temperature recirculate.

### BACKGROUND

Scale deposition can be a major problem in industrial, municipal, and residential water applications, with various sparingly soluble minerals depositing on the surfaces of pipes, water heater tanks, and membranes used in industrial and municipal water purification technologies such as reverse osmosis. Such scale deposition can inhibit water flow and increase operating pressures and their associated energy cost—an effect most noticeable in a reverse-osmosis apparatus, where high pressures are needed even for normal operation. To alleviate potential scaling problems, it is common to use an ion-exchange column or columns to remove potential scalants from a feed water stream, replacing such scalants with innocuous, highly-soluble compounds such as sodium chloride.

A typical ion-exchange column consists of a bed of particles, either clay zeolites or polymeric resins, containing groups of the opposite charge of the target ion to be trapped. Prior to exposure to the target ion, these groups are bound to labile ions of the appropriate charge—commonly sodium and chloride. Upon adsorption of the target ion, the labile ion is released in accordance with charge balance, resulting in a saline stream of proportional ionic strength to the influent. This has proved to be an excellent option for many water treatment applications due to its simplicity of operation and affordability.

Unfortunately, ion exchange columns have a limited lifetime; once all of the sodium or chloride has been displaced from the zeolite or resin, the column can no longer adsorb any of the various scale precursor ions and is said to be “exhausted.” FIG. 1 compares a typical ion exchange column at the start of operation to the exhausted column post-operation. The general solution to this problem is termed “regeneration” of the column and is performed as follows:
1. The bed is backwashed with water to decompress it and improve flow. This requires approximately 1× the bed volume (BV) worth of water.
2. The column is then flushed with a sodium chloride solution in order to displace the adsorbed scale precursor ions with sodium or chloride and thereby return the column to its original state. However, because the scale precursor ions have a higher affinity than sodium chloride for the zeolite or resin by design (so that the zeolite or resin can effectively remove them from solution in the first place), a very high concentration of sodium chloride in a very large volume of water is needed for regeneration—roughly 2-3 BV of a 10% (weight/volume) NaCl solution. On an industrial scale, this can mean 10-15 thousand liters of water per day for this step alone, bearing upwards of a metric ton of sodium chloride. Additionally, the effluent wastewater containing the desorbed scale precursor ions is extremely concentrated, potentially containing 10 grams per liter of hardness (calcium and magnesium ions).
3. The excess sodium chloride must then be rinsed from the column. This phase is referred to as the “slow rinse” and could require another 2-3 BV of clean, non-saline water.
4. A second rinsing phase, known as the “fast rinse,” follows, requiring an additional 4 BV of clean, non-saline water.

FIG. 2 compares a typical exhausted ion exchange column prior to regeneration to the regenerated column. Regeneration clearly presents several problems for the column operator:
high costs for obtaining the massive amount of sodium chloride required for the brine regeneration step;
high costs for the massive amount of water used throughout the process, totaling up to 5% by volume of the amount of water originally treated by the column; and
high costs for disposing of the 40-50 thousand liters per day of wastewater effluent if, due to regulatory limits, such is too saline and too hard to be simply dumped.

The ability to reuse the sodium chloride, the water, or both would be of substantial economic benefit to anyone using an ion exchange column. The effluent cannot, however, simply be sent back through the column as-is, because it contains all the scale precursor ions that the column had removed in the first place and would result in a still-exhausted column.

### BRIEF SUMMARY

This Summary is provided to introduce a selection of concepts in a simplified form that are further described below in the Detailed Description. This Summary is not intended to identify key or essential features of the invention.

Methods and systems for treating the effluent waste from a cation-exchange column regeneration cycle are disclosed herein. According to various embodiments, such methods and systems involve a high-recovery recycling process for the sodium chloride and water used during the regeneration cycle. Such methods and systems result in minimal liquid discharge, thereby eliminating much of the cost associated with materials acquisition and waste disposal in ion exchange column regeneration.

In one or more embodiments, an exhausted cation-exchange column is first backwashed with water warmer than room temperature (room temperature being about 20° C.) and then regenerated by passing regenerant brine (e.g., about 9.5 to about 11% weight/volume NaCl) at a temperature warmer than room temperature over the exhausted cation-exchange column. The waste effluent resulting from regeneration with the warm regenerant brine has a temperature warmer than room temperature and contains both the divalent cations captured by the column and the excess of sodium chloride needed to remove said cations from the resin. Next, the waste effluent resulting from regeneration proceeds to a precipitation reactor (e.g., an unseeded solids-contact-type reactor (SCR) or a seeded “pellet reactor” (fluidized bed reactor)) at a temperature warmer than room temperature, where divalent cations as carbonates or hydroxides (e.g., CaCO₃, Mg(OH)₂, BaCO₃, etc.) are precipitated. The treated effluent then proceeds through a filtration (e.g., ultrafiltration) unit to remove unsettled particles and, optionally, a pH adjustment unit, where the effluent is neutralized (e.g., to a pH of about 4 to about 7) with acid. The stream leaving the filtration step or optional pH adjustment step is then concentrated to about 9.5 to about 11% (weight/volume) NaCl using membrane-based purification technology (e.g., direct-contact membrane distillation (DCMD), air-gap membrane distillation (AGMD), vacuum membrane distillation (VCMD), sweeping-gas membrane distillation (SWGMD), etc.). According to various embodiments, reverse osmosis is not used in this concentration step. Separated concentrated brine and pure rinse water leaving the membrane-based water recovery unit are then fed back to the ion exchange unit for the next regeneration cycle. According to various embodiments, the sole source of heat may be a membrane distillation unit, from which water may exit at a temperature of from about 60° C. to about 70° C.

The system according to various embodiments comprises a recirculating, closed-loop brine and water system for said regeneration cycle, and includes the following components, in order: an exhausted ion (e.g., cation) exchange column, a chemical precipitation reactor, a filtration unit, an optional pH adjustment unit, and a membrane distillation unit. In certain embodiments, a portion of the stream leaving the filtration unit may be sent to crystallization equipment.

Additional embodiments are described herein.

### BRIEF DESCRIPTION OF THE DRAWINGS

Some embodiments are illustrated by way of example, and not by way of limitation, in the figures of the accompanying drawings.

FIG. 1 compares a typical ion exchange column at the start of operation to the exhausted column post-operation.

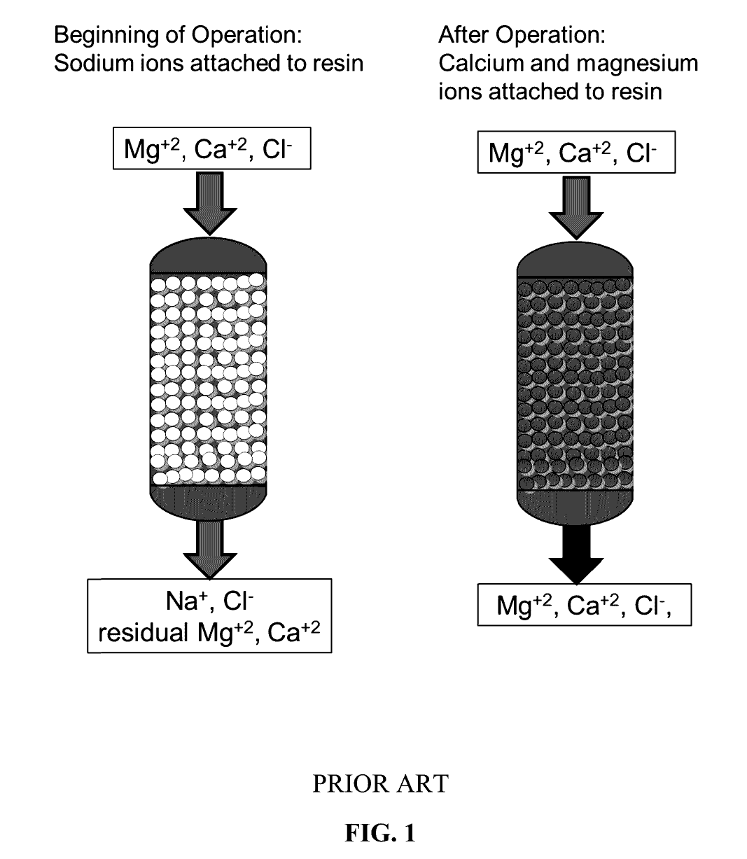

FIG. 2 compares a typical exhausted ion exchange column prior to regeneration to the regenerated column.

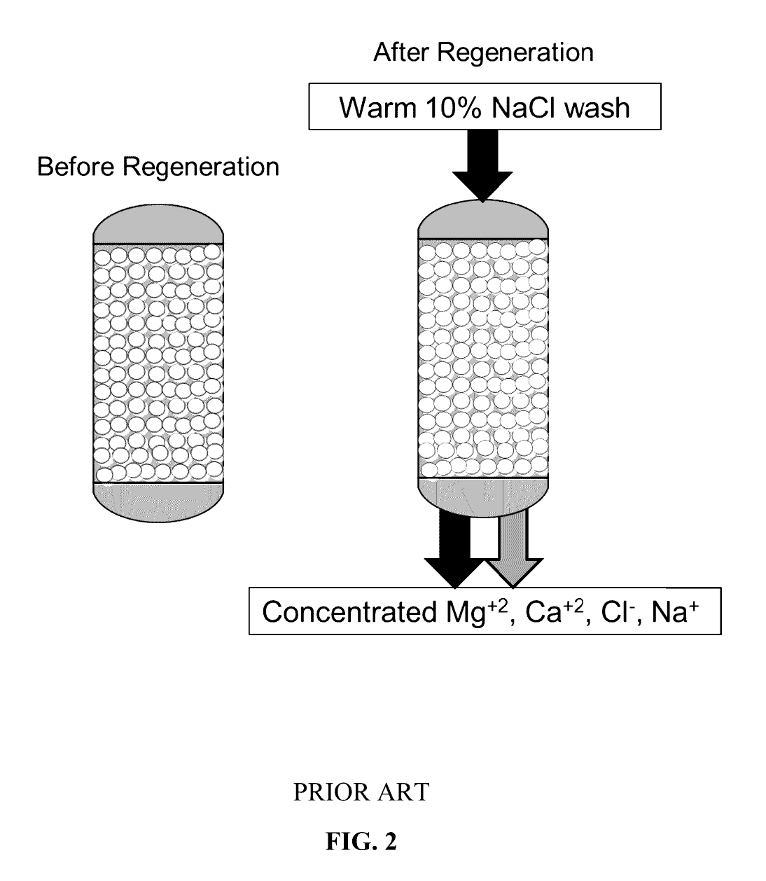

FIG. 3 illustrates a process diagram according to one or more aspects of the present application.

FIG. 4 illustrates a process diagram according to one or more aspects of the present application.

FIG. 5 demonstrates that precipitation efficiency improves with increasing temperature at a pH of 10.

FIG. 6 demonstrates the results of two runs of membrane distillation.

### DETAILED DESCRIPTION

The various embodiments are not limited to particular embodiments described herein. Further, the terminology used herein is for the purpose of describing particular embodiments only, and is not intended to be limiting.

Methods and systems for treating the effluent waste from a cation-exchange column regeneration cycle are disclosed herein. According to various embodiments, such methods and systems involve a high-recovery recycling process for the sodium chloride and water used during the regeneration cycle. Such methods and systems result in minimal liquid discharge, thereby eliminating much of the cost associated with materials acquisition and waste disposal in ion exchange column regeneration. According to various embodiments, about 99% or greater of the water used to regenerate the column may be recycled and reused, with about 1% or less liquid discharge.

Various embodiments are directed to a method comprising, consisting essentially of, or consisting of, i) a backwashing step, wherein an exhausted cation-exchange column is backwashed with backwash water; ii) a regeneration step, wherein rinse water having a temperature warmer than room temperature (room temperature being about 20° C.) and a regenerant brine comprising sodium chloride and having a temperature warmer than room temperature are passed over the exhausted cation-exchange column, thereby forming a waste effluent having a temperature warmer than room temperature and containing divalent cations and sodium chloride; iii) a precipitation step, wherein the waste effluent is fed at a temperature warmer than room temperature to a precipitation reactor where the divalent cations are precipitated as carbonates or hydroxides, thereby forming a treated effluent; iv) a filtration step, wherein the treated effluent proceeds through a filtration unit to remove unsettled particles, thereby forming a filtered effluent; v) an optional pH adjustment step, wherein the filtered effluent is neutralized (e.g., to a pH from about 4 to about 7) with acid, thereby forming a pH-adjusted effluent; vi) a membrane-based water recovery step, wherein the filtered effluent leaving the filtration step of iv) or the pH-adjusted effluent of the optional pH adjustment step of v) is concentrated via a membrane-based water recovery unit, thereby forming separated concentrated sodium chloride and pure rinse water; and vii) a recirculation step, wherein the separated concentrated sodium chloride and pure rinse water leaving the membrane-based water recovery unit are fed back to the cation-exchange column for a subsequent regeneration cycle; wherein ii)-vii) are repeated at least one time.

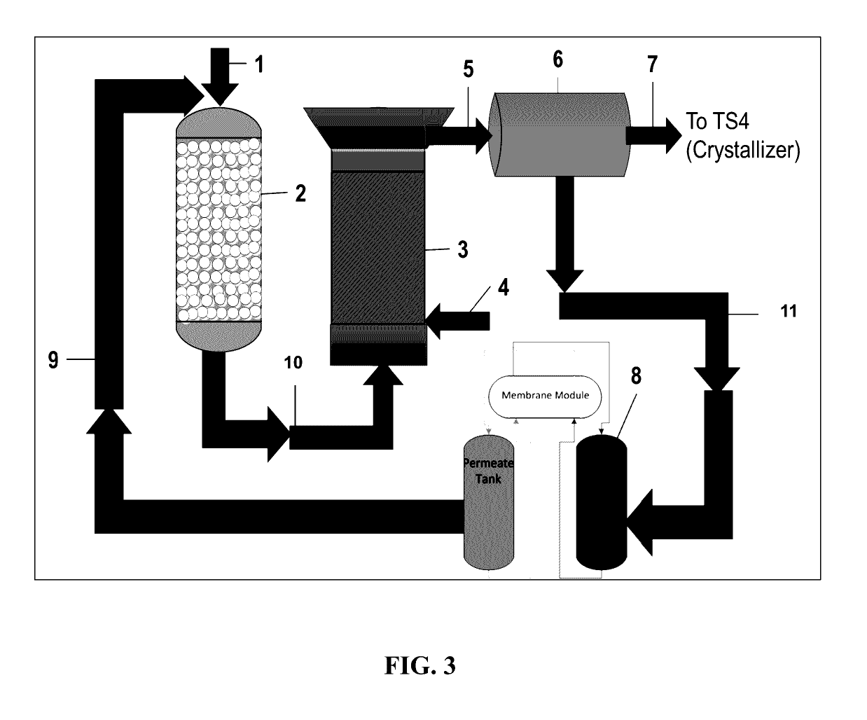

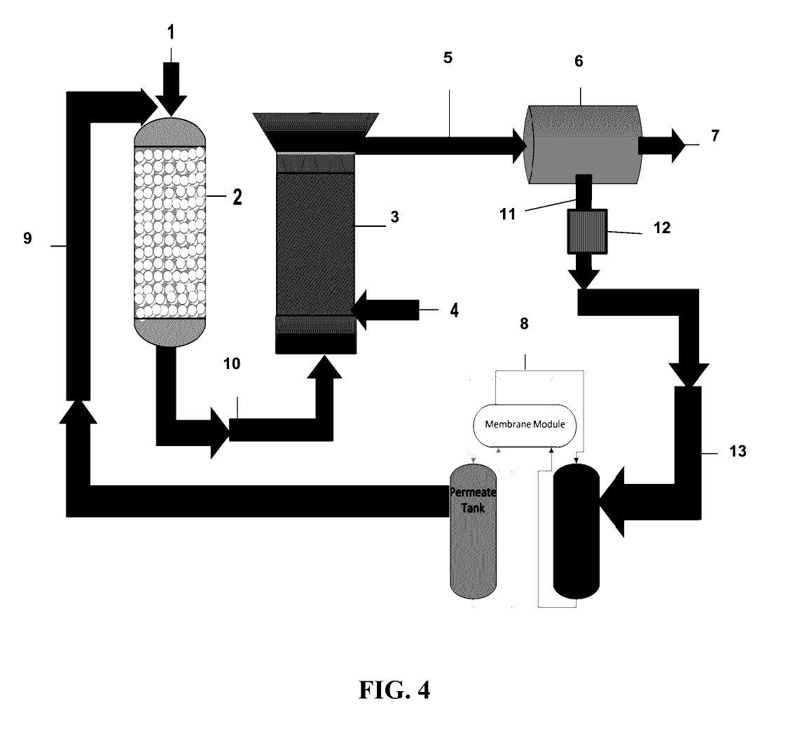

As illustrated in FIGS. 3 and 4, certain embodiments are directed to a system comprising, consisting essentially of, or consisting of, a recirculating, closed-loop brine and water system for a regeneration cycle, and including the following components, in order: an exhausted ion exchange column 2, a chemical precipitation reactor 3, a filtration unit 6, an optional pH adjustment unit 12 (not illustrated in FIG. 3), and a membrane distillation unit 8.

In one or more embodiments, the exhausted cation-exchange column 2 is first backwashed with backwash water (not illustrated in FIGS. 3 and 4). The backwashing step is not particularly limited. Conventional backwashing techniques may be used to decompress the column bed and improve flow (e.g., by removing extraneous particulates). In certain embodiments, the exhausted cation-exchange column 2 is backwashed with about 1× the BV worth of water. The backwashing water may be stored in a wastewater sump for later reuse.

According to various embodiments, the exhausted cation-exchange column 2 is regenerated by passing warm regenerant brine 1 over the exhausted cation-exchange column 2. The warm regenerant brine may be a saline solution comprising about 9.5 to about 11 g sodium chloride/100 mL and having a temperature warmer than room temperature. In some embodiments, the warm regenerant brine may be a saline solution comprising about 9.5, about 10, about 10.5 or about 11% (weight/volume) sodium chloride. In certain embodiments, the regenerant brine 1 has a temperature of from greater than 20° C. to about 60° C., from greater than 20° C. to about 50° C., from greater than 20° C. to about 40° C., from about 40° C. to about 60° C., from about 40° C. to about 55° C., from about 40° C. to about 50° C., from about 40° C. to about 45° C., from about 45° C. to about 60° C., from about 50° C. to about 60° C., or from about 55° C. to about 60° C., when passed over the exhausted cation-exchange column. In some embodiments, the regenerant brine 1 has a temperature of greater than 20° C., about 25° C., about 30° C., about 35° C., about 40° C., about 45° C., about 50° C., about 55° C., or about 60° C., when passed over the exhausted cation-exchange column. Without being bound by theory, the elevated temperature hastens the exchange process and raises the solubility of the salts of the desorbing cations, thereby resulting in a slightly more concentrated warm waste effluent.

In certain embodiments, other weakly-binding cations (e.g., lithium) may be used in addition to or as an alternative to sodium. A counterion in addition to or as an alternative to chloride (e.g., nitrate, bromide, etc.) may be used in certain embodiments, provided that such counterion would not form a precipitate with calcium or magnesium.

Residence time of a stream to be treated typically determines how complete the exchange will be. The manufacturer of each resin typically specifies a recommended amount of residence time. In certain embodiments, the regenerant flow is stopped for a period of time (e.g., one hour, etc.) so that the resin may soak and then flow is resumed (e.g., at about 0.2 bed volumes per minute (25 mL/min for a 115 mL bed)).

According to various embodiments, immediately after passing the warm regenerant brine 1 over the exhausted cation-exchange column 2, the column may be rinsed with rinse water 9 to remove excess sodium chloride. Such rinsing step is not particularly limited. Conventional slow and fast rinsing steps may be used; however, according to the present methods, the source of the rinse water is the pure rinse water leaving the membrane-based water recovery unit 8. In certain embodiments, the rinse water 9 has a temperature of from greater than 20° C. to about 60° C., from greater than 20° C. to about 50° C., from greater than 20° C. to about 40° C., from about 40° C. to about 60° C., from about 40° C. to about 55° C., from about 40° C. to about 50° C., from about 40° C. to about 45° C., from about 45° C. to about 60° C., from about 50° C. to about 60° C., or from about 55° C. to about 60° C., when passed over the regenerated cation-exchange column. In some embodiments, the rinse water 9 has a temperature of greater than 20° C., about 25° C., about 30° C., about 35° C., about 40° C., about 45° C., about 50° C., about 55° C., or about 60° C., when passed over the regenerated cation-exchange column.

The warm waste effluent 10 resulting from regeneration with the warm regenerant brine 1 has a temperature warmer than room temperature and contains both the divalent cations captured by the column 2 and the excess of sodium chloride needed to remove said cations from the resin. Representative examples of divalent cations contained in the warm waste effluent 10 include, but are not limited to, calcium, magnesium, barium, strontium and combinations thereof. In certain embodiments, the resin is regenerated from about 85 to about 100%, from about 90 to about 100%, from about 95 to about 100%, from about 90 to about 99%, from about 90 to about 98%, or from about 90 to about 95%. In some embodiments, the resin is about 85%, about 90%, about 95%, about 96%, about 97%, about 98%, about 99% or about 100% regenerated. Warm waste effluent 10 hardness depends on the extent of regeneration. In certain embodiments, the hardness of the warm waste effluent is about 2500-3000 ppm, most of which is due to calcium (e.g., about 80%), but with some magnesium also present. According to some embodiments, trace amounts of copper (e.g., about 5 ppm) and manganese (e.g., <1 ppm) may also be present in the warm waste effluent.

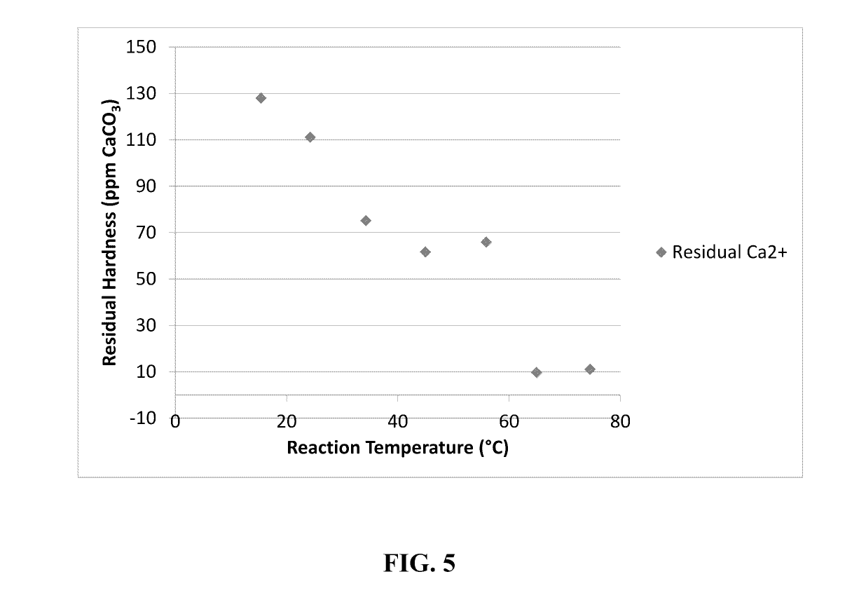

The warm waste effluent 10 containing both the divalent cations captured by the column 2 and the excess of sodium chloride needed to remove said cations from the resin proceeds to a precipitation reactor 3 at a temperature warmer than room temperature. In certain embodiments, the warm waste effluent 10 has a temperature of from greater than 20° C. to about 50° C., from greater than 20° C. to about 40° C., from about 20° C. to about 30° C., from about 30° C. to about 40° C., from about 30° C. to about 50° C., from about 35° C. to about 50° C., from about 40° C. to about 50° C., or from about 45° C. to about 50° C. In some embodiments, the warm waste effluent 10 proceeds to the precipitation reactor 3 at a temperature of greater than 20° C., about 25° C., about 30° C., about 35° C., about 40° C., about 45° C. or about 50° C. In the precipitation reactor 3, the divalent cations may be precipitated as carbonates or hydroxides. Representative examples of species precipitated include, but are not limited to, CaCO₃, Mg(OH)₂, BaCO₃, SrCO₃ and combinations thereof. In certain embodiments, trace amounts of transition and/or post-transition metals (e.g. iron, manganese, copper, aluminum, etc.) may be present in the treated water and thus, carbonates and/or hydroxides of such may also be precipitated. The most commonly precipitated species—calcium carbonate (CaCO₃) and magnesium hydroxide (Mg(OH)₂)—both exhibit retrograde solubility. Thus, without being bound by theory, the warm conditions employed here will result in lower solubility of these two compounds and higher precipitation efficiency. FIG. 5 demonstrates that precipitation efficiency, at least at a pH of 10, improves with increasing temperature.

In certain embodiments, the precipitation step removes about 85 to about 99% of calcium ions and about 85 to about 95% of magnesium ions present in the warm waste effluent. In come embodiments, the precipitation step removes about 95 to about 99% of calcium ions and about 90 to about 95% of magnesium ions present in the warm waste effluent. According to certain embodiments, the precipitation step removes about 85%, about 90%, about 95%, about 96%, about 97%, about 98% or about 99% of calcium ions present in the warm waste effluent. According to some embodiments, the precipitation step removes about 85%, about 90%, about 91%, about 92%, about 93%, about 94% or about 95% of magnesium ions present in the warm waste effluent.

During the precipitation step, the warm waste effluent containing both the divalent cations captured by the column 2 and the excess of sodium chloride needed to remove said cations from the resin may be supplemented with a source of alkalinity 4. Exemplary forms of such source of alkalinity 4 include, but are not limited to, sodium bicarbonate, sodium carbonate, sodium hydroxide, calcium hydroxide and combinations thereof. In certain embodiments, one source of alkalinity 4 is used. In other embodiments, two or more sources of alkalinity 4 are used, including any two or more, three or more, four or more, etc., of the sources of alkalinity detailed herein. For example, in certain embodiments, the source of alkalinity 4 includes sodium bicarbonate and sodium hydroxide, or sodium carbonate and sodium hydroxide. In certain embodiments, the warm waste effluent is supplemented with sodium bicarbonate, sodium carbonate, or a combination thereof such that there is a slight molar excess of carbonate species as compared to hardness ions (e.g, calcium ions, magnesium ions, or combinations thereof). In further embodiments, sodium hydroxide and/or calcium hydroxide may also be added in a sufficient quantity to raise the pH of the warm waste effluent to at least about 10 to about 11.5 for about 95 to about 97% calcium removal or to at least about 11.4 to about 11.7 for about 99% calcium removal and about 85 to about 90% magnesium removal.

In certain embodiments, the warm waste effluent is supplemented with the source(s) of alkalinity 4 in an amount sufficient to raise the pH of the warm waste effluent to about 10 to about 11.7, about 10 to about 11.6, about 10 to about 11.5, about 10 to about 11.4, about 10 to about 11.3, about 10 to about 11.2, about 10 to about 11.1, about 10 to about 11, about 10 to about 10.5, about 11 to about 11.7, about 11.1 to about 11.7, about 11.2 to about 11.7, about 11.3 to about 11.7, about 11.4 to about 11.7, about 11.5 to about 11.7, or about 11.6 to about 11.7. In certain embodiments, the warm waste effluent is supplemented with the source(s) of alkalinity 4 in an amount sufficient to raise the pH of the warm waste effluent to about 10, about 10.5, about 11, about 11.1, about 11.2, about 11.3, about 11.4, about 11.5, about 11.6, or about 11.7.

The precipitation reactor 3 may be a seeded “pellet reactor” (e.g., fluidized bed reactor), unseeded solids-contact-type reactor (SCR), or combination thereof.

In certain embodiments, a SCR is used to execute the precipitation step. In the SCR, the warm waste effluent is pumped into an empty column from the bottom, along with a sufficient amount of the source of alkalinity 4 to precipitate the target amount of divalent cations as carbonates or hydroxides (e.g., CaCO₃, Mg(OH)₂, BaCO₃, SrCO₃, etc.). The combined warm waste effluent and source of alkalinity 4 is slowly stirred in this column, nucleating and growing precipitate particles with a minimum of shear forces but with adequate distribution of reactants. The formed suspension then flows over the top of the column and into a cylindro-conical tank where the precipitate can settle as it moves to a filtration unit. In certain embodiments, stirring speed is kept low (e.g., about 60 rom). According to some embodiments, a residence time of about 0.5 to about 2 hours or about 1 to 2 hours is used.

In other embodiments, the precipitation step is conducted with a seeded “pellet reactor” (e.g., fluidized bed reactor). The pellet reactor operates on much the same principle as the SCR, except that the warm waste effluent and source of alkalinity 4 are pumped upward through a bed of seed particles (e.g., garnet sand, calcium carbonate, granular activated carbon, or a combination thereof). The precipitates then grow on the seed surface, forming larger, heavier particles that settle into a more compact bed at the bottom of the reactor. These heavy, coated particles are withdrawn from the reactor at regular intervals.

Irrespective of the precipitation reactor 3 type, the treated effluent 5 exiting the precipitation reactor 3 may contain saline water from the brine regeneration step, water from the rinsing steps (having a low NaCl concentration), additional sodium from the addition of sodium carbonate, sodium bicarbonate, sodium hydroxide, or a combination thereof (if applicable), a small amount of unreacted calcium and magnesium, and negligible amounts of other divalent cations. In certain embodiments, these components should generally be less than or equal to 30 ppm. The nature of the “other divalent cations” depends entirely on the composition of the effluent waste and could include iron (II), copper (II), cobalt (II), zinc (II), manganese (II), etc. Unreacted calcium and magnesium may be present only in high enough concentrations for their prospective precipitates to have saturation indices of about 0 to about 4—depending on the pH, temperature, and carbonate content, this could be nearly quantitative removal to several hundred ppm of residual hardness ions.

Regardless of the precipitation reactor 3 type, the treated effluent leaving the precipitation reactor 3 then proceeds through a filtration unit 6 (e.g., an ultrafiltration unit) to remove unsettled particles. The filtration step is not particularly limited. Conventional filtration techniques may be used to remove unsettled particles from the treated effluent. In certain embodiments, a filter (e.g., a PVDF filter) having a pore size of about 0.2 micron to about 1 micron, about 0.5 micron to about 1 micron, or about 0.2 to about 0.5 micron may be used. In some embodiments, a filter (e.g., a PVDF filter) having a pore size of about 0.2 micron, about 0.3 micron, about 0.4 micron, about 0.5 micron, about 0.6 micron, about 0.7 micron, about 0.8 micron, about 0.9 micron or about 1 micron may be used. The treated effluent being filtered may, in certain embodiments, have a temperature of from about 20° C. to about 40° C., from about 25° C. to about 40° C., from about 30° C. to about 40° C., from about 35° C. to about 40° C., from about 20° C. to about 35° C., or from about 20° C. to about 30° C. In some embodiments, the treated effluent being filtered may have a temperature of about 20° C., greater than 20° C., about 25° C., about 30° C., about 35° C., or about 40° C.

The filtered effluent 11 may optionally proceed to a pH adjustment step, wherein the filtered effluent 11 is neutralized (e.g., to a pH of about 4 to about 7) with acid in a pH adjustment unit 12. In some embodiments, the pH of the filtered effluent 11 is adjusted to a pH of about 4, about 5, about 6 or about 7. The filtered effluent 11 being pH-adjusted may, in certain embodiments, have a temperature of from about 20° C. to about 40° C., from about 25° C. to about 40° C., from about 30° C. to about 40° C., from about 35° C. to about 40° C., from about 20° C. to about 35° C., or from about 20° C. to about 30° C. In some embodiments, the filtered effluent 11 being pH-adjusted may have a temperature of about 20° C., greater than 20° C., about 25° C., about 30° C., about 35° C., or about 40° C. Re-using the water without neutralizing the pH may result in the formation of hydroxides within the ion-exchange column when the divalent cations are released, scaling the resin and rendering it useless. An additional benefit of pH adjustment is that any excess carbonate present in the system that could contribute to scale formation is converted to carbon dioxide, which can then be easily removed from the stream during the subsequent membrane purification process. Exemplary acids useful in the pH adjustment step include, but are not limited to, hydrochloric acid, sulfuric acid, perchloric acid, nitric acid, hydrobromic acid, hydroiodic acid, acetic acid and combinations thereof. Though sulfuric acid is typically a more economical choice than hydrochloric, the sulfate byproduct of the neutralization reaction could potentially present gypsum (CaSO₄) scaling problems in the resin. Gypsum formation is essentially unaffected by pH level, and thus pH control would not help. Acids with conjugate bases that may be trapped or co-precipitated with the waste could present an environmental hazard and thus, should be avoided. Hydrochloric acid is therefore the safer and recommended choice, especially because the water will undergo many pH neutralization cycles as it is reused.

The stream 13 exiting the pH adjustment unit 12 may contain saline water from the brine regeneration step, water from the rinsing steps (having a low NaCl concentration), additional sodium from the addition of sodium carbonate, sodium bicarbonate, sodium hydroxide, or a combination thereof (if applicable), additional chloride from the hydrochloric acid (if applicable) used in the pH adjustment step, a small amount of unreacted calcium and magnesium, and negligible amounts of other divalent cations. In certain embodiments, calcium is present in an amount of about 150 ppm or less as CaCO₃, magnesium is present in an amount of about 80 ppm or less as CaCO₃, and other cations excluding alkali metals are present in an amount of <1 ppm each. In certain embodiments, sodium chloride is present in an amount of about 3 to about 8% (weight/volume), about 4 to about 8% (weight/volume), about 5 to about 8% (weight/volume), about 6 to about 8% (weight/volume), about 7 to about 8% (weight/volume), about 3 to about 7% (weight/volume), about 3 to about 6% (weight/volume), about 3 to about 5% (weight/volume) or about 3 to about 5% (weight/volume). The unreacted calcium and magnesium are present only in high enough concentrations for their prospective precipitates to have saturation indices of 0 to 4—depending on the pH, temperature, and carbonate content, this could be nearly quantitative removal to several hundred ppm of residual hardness ions.

While the waste effluent could have taken on additional sodium chloride from the added sodium carbonate, sodium bicarbonate, sodium hydroxide, hydrochloric acid, or combination thereof (if applicable), the combined stream would not be saline enough to be reused directly in the brine regeneration step 1, nor would it be pure enough to be used in a rinsing step 9. In certain embodiments, the combined stream would contain about 3 to about 8% (weight/volume) sodium chloride, less than about 180 ppm hardness and negligible (e.g., less than 5 ppm) other non-sodium chloride compounds. By using a membrane-based purification technology, pure water can be extracted from the stream for reuse in the rinsing steps 9, leaving behind a more concentrated saline solution suitable for the brine regeneration step 1.

In order to be suitable for the brine regeneration step 1, the purified brine stream will need to be concentrated to about 9.5 to about 11% (weight/volume) NaCl, thus requiring a high capacity for salinity tolerance in the membrane purification unit. In certain embodiments, the purified brine stream is concentrated to about 9.5% (weight/volume) NaCl, about 10% (weight/volume) NaCl, about 10.5% (weight/volume) NaCl or about 11% (weight/volume) NaCl. In various embodiments, this excludes the possibility of using a reverse osmosis (RO) unit, as the maximum NaCl content of brines treatable by RO is generally only 7%. Even if a RO unit were able to treat brines in excess of 7% salinity, the power costs associated with overcoming the high osmotic pressure of such a system would be astronomical. Instead, various embodiments herein utilize a membrane distillation (“MD”) unit 8.

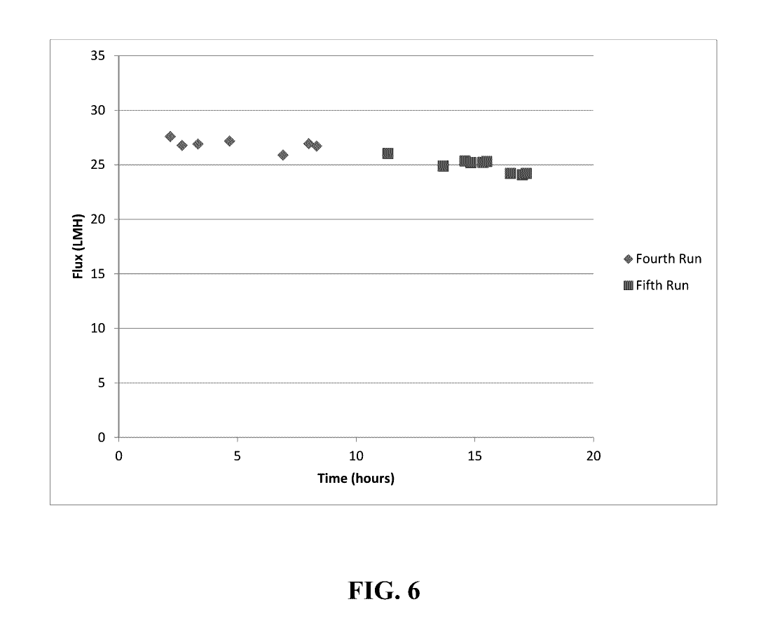

There are several configurations that can be used for membrane distillation 8. Exemplary membrane distillation 8 techniques for concentrating the stream leaving the filtration step or the optional pH adjustment step include, but are not limited to, direct-contact membrane distillation (DCMD), air-gap membrane distillation (AGMD), vacuum membrane distillation (VCMD), sweeping-gas membrane distillation (SWGMD), and combinations thereof. The major advantages of using MD, whatever the configuration may be, as opposed to RO in the system according to various embodiments herein are as follows:
a. The water in the stream is already warm when MD is used. This reduces the amount of energy that needs to be put into the system. Additionally, waste heat from the general operation of the plant can be used to (re)heat the stream, which may only need to reach about 70° C. for good MD water recovery rates. The target recovery rate is sufficient to achieve about 9.5 to about 11% NaCl (w/v). For example, if one were to achieve 10% NaCl (w/v) starting with a 7% NcCl (w/v) stream, this means recovering 30% of the water. The temperature of the cold side in direct-contact membrane distillation (DCMD) can be, for example, about 20 to about 40° C. (in the inlet) with no noticeable change in performance, but lowering the hot side by even about 10° C. (e.g., from about 70° C. to about 60° C.) may result in a drop in the flux from about 25 to about 30 L m⁻² h⁻¹ (“LMH”) to about 11 to about 12 LMH.
b. MD has a higher capacity for sodium chloride tolerance as compared to RO. See, for example, Greenlee L. F., Lawler D. F., Freeman B. D., Marrot B., and Moulin P. Reverse osmosis desalination: Water sources, technology, and today's challenges. Water Research 43 (2009), 2317-2348. Note maximum 50% recovery for seawater of 35,000 ppm TDS. Also, see FIG. 6, which illustrates the results of two runs of the direct-contact membrane distillation (DCMD) starting at 100 g/L NaCl (for each run) and ending at 141 g/L and 152 g/L, respectively, maintaining about 80% minimum of the initial flux (30 LMH).
c. MD may implicate lower energy costs than RO. According to various embodiments of the present application, the sole source of heat may be a membrane distillation unit, from which water may exit at a temperature of from about 60° C. to about 70° C. In contrast, RO typically requires the use of additional energy sources.
d. MD has a lower fouling tendency than RO. In RO, liquid water is pushed through the membrane by force, pressing all dissolved and suspended contaminants onto the membrane surface. MD's fouling resistance extends membrane lifetime and enhances its adaptability to fluctuations in solute concentration. See, for example, Warsinger D. M., Swaminathan J., Guillen-Burrieza E., Arafat H. A., and Lienhard J. H. V. Scaling and fouling in membrane distillation for desalination applications: A review. Desalination 356 (2015), 294-313. Also: Srisurichan S., Jiraratananon R., and Fane A. G. Humic acid fouling in the membrane distillation process. Desalination 174 (2005), 63-72.

Direct-contact membrane distillation (DCMD) is a technique in which the stream of brine to be treated is pumped across one side of a membrane at an elevated temperature, while a stream of clean water is pumped across the opposite side of the membrane at a lower temperature (the two streams are in direct contact, separated only by the membrane). The difference in the vapor pressure of the water on each side of the membrane arising from this temperature difference results in a net flow of water vapor from the hot side to the cold side of the membrane. To ensure that only water vapor crosses the membrane and that liquid water does not shuttle ions across, a micro- or nanoporous membrane made of a highly hydrophobic material is used, thereby inhibiting liquid water from wetting the membrane and keeping liquid water and ions on the hot side of the membrane due to the cohesive and attractive forces binding them together that gaseous water has overcome. Representative hydrophobic membrane materials include, but are not limited to, polyethersulfone (PES), polytetrafluoroethylene (PTFE), polyethylene (PE), polypropylene (PP), polyvinylidene fluoride (PVDF) and combinations thereof.

In certain embodiments, the DCMD unit may be operated with a brine stream flowing counter to a permeate stream, the brine stream having a temperature of about 60 to about 80° C., and the permeate stream having a temperature of about 20 to about 40° C. In some embodiments, the DCMD unit may be operated with a brine stream flowing counter to a permeate stream, the brine stream having a temperature of about 60 to about 70° C., about 60 to about 71° C., about 60 to about 75° C., about 65 to about 80° C., about 65 to about 75° C., about 65 to about 71° C., about 65 to about 70° C., about 70 to about 71° C., about 70 to about 75° C., about 70 to about 80° C. about 71 to about 75° C., about 71 to about 80° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., or about 80° C. In certain embodiments, the DCMD unit may be operated with a brine stream flowing counter to a permeate stream, the permeate stream having a temperature of about 25 to about 40° C., about 30 to about 40° C., about 35 to about 40° C., about 20 to about 35° C., about 20 to about 30° C., about 20 to about 25° C., about 20° C., about 25° C., about 30° C., about 35° C. or about 40° C. Although certain brine stream and certain permeate stream temperatures are used to illustrate certain variations, the various embodiments are not to be limited in scope by the specific embodiments disclosed. With the benefit of the present disclosure, one skilled in the art will recognize that brine stream and permeate stream temperatures may need to be adjusted depending on a particular process parameter (e.g., a target flux). For instance, in certain embodiments, the higher the brine stream temperature, the higher the flux.

According to certain embodiments, both the permeate stream and the brine stream flow at about 87 to about 93 liters per hour. In certain embodiments, the flow rate of the permeate stream may be the same as that of the brine stream. In other embodiments, the flow rate of the permeate stream may differ from that of the brine stream. In some embodiments, both the permeate stream and the brine stream may flow at about 88 to about 93 liters per hour, about 89 to about 93 liters per hour, about 90 to about 93 liters per hour, about 91 to about 93 liters per hour, about 92 to about 93 liters per hour, about 87 to about 92 liters per hour, about 87 to about 91 liters per hour, about 87 to about 90 liters per hour, about 87 to about 89 liters per hour, about 87 to about 88 liters per hour, about 87 liters per hour, about 88 liters per hour, about 89 liters per hour, about 90 liters per hour, about 91 liters per hour, about 92 liters per hour, or about 93 liters per hour. In other embodiments, at least one of the permeate stream and the brine stream may flow at about 88 to about 93 liters per hour, about 89 to about 93 liters per hour, about 90 to about 93 liters per hour, about 91 to about 93 liters per hour, about 92 to about 93 liters per hour, about 87 to about 92 liters per hour, about 87 to about 91 liters per hour, about 87 to about 90 liters per hour, about 87 to about 89 liters per hour, about 87 to about 88 liters per hour, about 87 liters per hour, about 88 liters per hour, about 89 liters per hour, about 90 liters per hour, about 91 liters per hour, about 92 liters per hour, or about 93 liters per hour. Although certain flow rates are used to illustrate certain variations, the various embodiments are not to be limited in scope by the specific embodiments disclosed. With the benefit of the present disclosure, one skilled in the art will recognize that flow rate may need to be adjusted to compensate for a particular membrane distillation unit and/or particular membrane size. For instance, in certain embodiments, the larger the membrane distillation unit, the more flow that can be produced.

One of the challenges of direct-contact membrane distillation, in general, is the fact that heat transfer between the feed and permeate streams lessens the temperature difference between the streams, in turn lowering the vapor pressure difference that drives the process. To combat this, systems have been experimented with possessing an air gap between the feed and permeate streams to thermally insulate the respective streams. This configuration is termed, appropriately, “air-gap membrane distillation” (AGMD). However, the mass transfer properties of AGMD units tend to be not as good as those of DCMD units.

Applying a vacuum inside the air gap can improve the mass transfer properties of AGMD, while simultaneously lowering the boiling point of the water in the feed stream, in turn reducing thermal energy requirements. Such a configuration is termed vacuum membrane distillation (VCMD). There are, however, increased electrical energy requirements for operating the vacuum pump, as well as increased costs from vacuum pump maintenance. VCMD can also affect feed pH, as it can extract carbonate in the form of CO₂:

HCO₃⁻(aq)+H⁺(aq) [symbol] H₂CO₃(aq) [symbol] H₂O(l)+CO₂(g)

Such H⁺ consumption can raise the solution pH, increasing the potential for scale formation. The fourth major configuration is known as the “sweeping-gas membrane distillation” (SWGMD) configuration. It also contains a gap between the feed and permeate streams, but rather than leaving stagnant air or a vacuum within the gap, the gap is continuously flushed with a carrier gas to force the water vapor to a condenser, where it can be collected. This significantly improves the mass transport properties over AGMD, but the increased mass flow of carrier gas presents heat transfer challenges—specifically, preventing the carrier gas from warming due to its contact with the feed stream and cooling it sufficiently in the condenser to force as much water out as possible.

Regardless of the MD configuration used, the effluent stream leaving the MD unit would then be sufficiently concentrated for re-use in the brine regeneration step 1. In certain embodiments, the effluent stream is concentrated to about 9.5 to about 11% (weight/volume) NaCl, thus requiring a high capacity for salinity tolerance in the membrane purification unit. In some embodiments, the purified brine stream is concentrated to about 9.5% (weight/volume) NaCl, about 10% (weight/volume) NaCl, about 10.5% (weight/volume) NaCl or about 11% (weight/volume) NaCl using the MD unit. The pure permeate that crossed the membrane into the cold-water stream can be re-used in the rinsing steps (9). Precipitate sludge from the precipitation reactor can be dried, lowering disposal costs relative to liquid waste and, if the precipitate is pure enough, enabling options for re-sale and/or crystallization (e.g., via crystallization equipment such as a TS4 crystallizer) 7.

According to various embodiments, the closed-loop system may be operated continuously or semi-continuously.

The present methods and systems have clear potential for the following:
1. Greatly reducing costs for purchasing the sodium chloride used to regenerate the resin.
2. Greatly reducing costs for purchasing the water used in the brine regeneration and rinsing steps of the regeneration process.
3. Greatly reducing disposal costs of the large volumes of hard, salty water produced.
4. Greatly reducing energy consumption costs as compared to other membrane-based purification technologies (e.g., RO) by using waste heat to drive the MD process.
5. Greater precipitation efficiency of the regeneration effluent due to elevated temperature.
6. More compact precipitate bed due to elevated temperature.
7. Greater membrane lifetime as compared to other membrane-based purification technologies (e.g., RO).

The various embodiments are not to be limited in scope by the specific embodiments disclosed in the examples. The specific embodiments disclosed in the examples are intended as illustrations of a few aspects, and any embodiments that are functionally equivalent are within the scope of this disclosure. Indeed, various modifications of the various embodiments in addition to those shown and described herein will become apparent and are intended to fall within the scope of the appended claims.

Although certain salts are used to illustrate certain variations, the various embodiments are suitable for the regeneration of any exhausted cation exchange column disclosed herein, using any of the components disclosed herein. With the benefit of the present disclosure, one skilled in the art will recognize that various parameters may need to be adjusted to compensate for the use of a different component.

The terms used in the present specification shall be understood to have the meaning usually used in the field of art to which the various embodiments pertain, unless otherwise specified.

Where systems are described herein as having, including, or comprising specific components, or where processes are described herein as having, including, or comprising specific process steps, it is contemplated that the systems of the various embodiments can also consist essentially of, or consist of, the recited components, and that the processes of the various embodiments also consist essentially of, or consist of, the recited process steps.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, a numerical range of “1 to 5” should be interpreted to include not only the explicitly recited values of 1 and 5, but also individual values and sub-ranges within the indicated range. Thus, included in this numerical range are individual values such as 2, 3, 4, etc. and sub-ranges such as from 1 to 3, from 2 to 4, from 3-5, etc. The listing of exemplary values or ranges is not a disclaimer of other values or ranges between and including the upper and lower limits of a given range.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope or spirit of the disclosure. Unless specified otherwise, any recited method can be carried out in the order of events recited or in any other order which is logically possible.

What is claimed is:

1. A method comprising
i) a backwashing step, wherein an exhausted cation-exchange column is backwashed with backwash water;
ii) a regeneration step, wherein rinse water having a temperature of from about 40° C. to about 60° C. and a regenerant brine comprising sodium chloride and having a temperature of from about 40° C. to about 60° C. are passed over the exhausted cation-exchange column, thereby forming a waste effluent having a temperature of from about 40° C. to about 60° C. and containing divalent cations and sodium chloride;
iii) a precipitation step, wherein the waste effluent is fed at a temperature of from about 30° C. to about 50° C. to a precipitation reactor where the divalent cations are precipitated as carbonates or hydroxides, thereby forming a treated effluent;
iv) a filtration step, wherein the treated effluent proceeds through a filtration unit to remove unsettled particles, thereby forming a filtered effluent;
v) an optional pH adjustment step, wherein the filtered effluent is neutralized with acid, thereby forming a pH-adjusted effluent;
vi) a membrane-based water recovery step, wherein the filtered effluent leaving the filtration step of iv) or the pH-adjusted effluent of the optional pH adjustment step of v) is concentrated via a membrane-based water recovery unit, thereby forming separated concentrated sodium chloride and pure rinse water having a temperature of from about 60° C. to about 70° C.; and
vii) a recirculation step, wherein the separated concentrated sodium chloride and pure rinse water leaving the membrane-based water recovery unit are fed back to the cation-exchange column for a subsequent regeneration cycle;
wherein ii)-vii) are repeated at least one time.

2. The method according to claim 1, wherein the regenerant brine of the regeneration step of ii) has a sodium chloride content of about 9.5 to about 11% weight/volume.

3. The method according to claim 1, wherein the precipitation step of iii) comprises feeding the waste effluent at a temperature of from about 30° C. to about 50° C. to a fluidized bed reactor or an unseeded solids-contact-type reactor (SCR).

4. The method according to claim 3, wherein the precipitation step of iii) comprises feeding the waste effluent at a temperature of from about 30° C. to about 50° C. to a fluidized bed reactor charged with garnet sand, calcium carbonate, granular activated carbon or a combination thereof.

5. The method according to claim 1, wherein the precipitation step of iii) comprises feeding the waste effluent at a temperature of from about 30° C. to about 50° C. and an alkaline stream comprising sodium bicarbonate, sodium carbonate, sodium hydroxide, calcium hydroxide or a combination thereof to the precipitation reactor.

6. The method according to claim 1, wherein the divalent cations are precipitated as CaCO₃, Mg(OH)₂, BaCO₃, SrCO₃ or a combination thereof in the precipitation step of iii).

7. The method according to claim 5, wherein the divalent cations comprise calcium ions and magnesium ions, and the precipitation step of iii) removes 85-99% of calcium ions and 85-95% of magnesium ions present in the waste effluent.

8. The method according to claim 5, wherein the precipitation step of iii) comprises feeding the waste effluent and the alkaline stream thereof to the precipitation reactor, wherein the alkaline stream is fed in an amount sufficient to raise the waste effluent pH to about 10-about 11.5.

9. The method according to claim 1, wherein the treated effluent proceeds through an ultra-filtration unit in the filtration step of iv).

10. The method according to claim 1, wherein the pH adjustment step of v) comprises neutralizing the effluent with hydrochloric acid.

11. The method according to claim 1, wherein the membrane-based water recovery step of vi) comprises concentrating the filtered effluent leaving the filtration step of iv) or the pH-adjusted effluent of the optional pH adjustment step of v) via a direct-contact membrane distillation (DCMD) unit, an air-gap membrane distillation (AGMD) unit, a vacuum membrane distillation (VCMD) unit, or a sweeping-gas membrane distillation (SWGMD) unit.

12. The method according to claim 11, wherein the DCMD unit is operated with a brine stream flowing counter to a permeate stream, the brine stream having a temperature of about 60 to about 80° C., the permeate stream having a temperature of about 20 to about 40° C., and both the permeate stream and the brine stream flowing at about 87 to about 93 liters per hour.

13. The method according to claim 1, wherein the membrane-based water recovery step of vi) comprises concentrating the filtered effluent leaving the filtration step of iv) or the pH-adjusted effluent of the optional pH adjustment step of v) via a membrane comprising polyethersulfone, polytetrafluoroethylene, polyethylene, polypropylene, polyvinylidene fluoride or a combination thereof.

14. The method according to claim 1, wherein the membrane-based water recovery step of vi) does not comprise reverse osmosis.

15. The method according to claim 1, wherein the filtered effluent leaving the filtration step of iv) or the pH-adjusted effluent of the optional pH adjustment step of v) is concentrated to about 9.5 to about 11% weight/volume sodium chloride in the membrane-based water recovery step of v).

16. A system comprising, in order:
i) an exhausted cation-exchange column;
ii) a chemical precipitation reactor;
iii) a filtration unit;
iv) an optional pH adjustment unit; and
v) a membrane-based water recovery unit,
wherein the system is a closed-loop system through which sodium chloride and rinse water having a temperature higher than room temperature recirculate.

17. The system according to claim 16, wherein the chemical precipitation reactor of ii) comprises a fluidized bed reactor or an unseeded solids-contact-type reactor (SCR).

18. The system according to claim 17, wherein the fluidized bed reactor is charged with garnet sand, calcium carbonate, granular activated carbon or a combination thereof.

19. The system according to claim 16, wherein the filtration unit is an ultra-filtration unit.

20. The system according to claim 16, wherein the membrane-based water recovery unit is a membrane distillation unit.

21. The system according to claim 20, wherein the membrane-based water recovery unit comprises a direct-contact membrane distillation (DCMD) unit, an air-gap membrane distillation (AGMD) unit, a vacuum membrane distillation (VCMD) unit, or a sweeping-gas membrane distillation (SWGMD) unit.

22. The system according to claim 16, wherein the membrane-based water recovery unit does not comprise a reverse osmosis unit.

23. The system according to claim 20, wherein the membrane distillation unit comprises a polyethersulfone, polytetrafluoroethylene, polyethylene, polypropylene, or polyvinylidene fluoride membrane.
